(19) United States
(12) Patent Application Publication
(10) Pub. No.: US 2012/0167474 A1
(43) Pub. Date: Jul. 5, 2012

(54) DOOR COMPRISING A DRIVE SYSTEM

(75) Inventor: Gerd Schaaf, Kirchheim/Teck (DE)

(73) Assignee: SOMMER ANTRIEBS-UND FUNKTECHNIK GMBH, KIRCHHEIM/TECK (DE)

(21) Appl. No.: 13/395,299

(22) PCT Filed: Sep. 3, 2010
(86) PCT No.: PCT/EP10/05425

§ 371 Date: Mar. 9, 2012

(30) Foreign Application Priority Data
Sep. 16, 2009 (DE) 102009041871.7

(51) Int. Cl. E06B 5/00; E05D 13/00; E06B 9/11; E05F 1/16

(52) U.S. Cl. 49/445; 16/72; 16/75; 160/224; 160/133; 160/318

(57) ABSTRACT

A weight compensation system is provided for a motor driven door having a door leaf that is driven by a mechanism inside guide rails on a side of the door leaf to move the door between an opened position and a closed position. The weight compensation system includes a weight-compensation device comprising a cable unit and a spring unit arranged at least on one side of the door leaf, wherein the cable unit comprises a single cable. A cable-tension compensation device at which the single cable is deflected creates two cable strands that are secured against breakage within the cable-tension compensation device. The cable-tension compensation device is positioned locally fixed or secured to the door leaf so that two cable strands move at a distance to each other, and the exposed ends of the cable are guided together and attached to the door leaf or are positioned locally fixed, respectively.

### CROSS-REFERENCE TO RELATED APPLICATIONS

This application is a U.S. National Stage Application of International Application No. PCT/EP2010/005425, filed Sep. 3, 2010, designating the United States and claiming priority to German Application No. DE 10 2009 041 871.7, filed on Sep. 16, 2009.

### BACKGROUND OF THE INVENTION

The invention relates to a drive system by which a door leaf of a door may be guided inside rails on the side of the door which can be moved between an opened position and a closed position, wherein the drive system includes a weight-compensation device comprising a cable unit and a spring unit on at least one side of the door and a cable-tension compensation device that is assigned to the cable unit.

A drive system of this type is known from European patent document EP 0 890 010 B1, which describes a door comprising a door leaf guided inside guide rails that are mounted on the side and movable overhead, wherein the door leaf can be moved with the aid of a drive system between an opened position and a closed position. A weight-compensation device is provided for compensating the weight of the door leaf and to ensure that the door leaf remains in place in each position, for example to avoid an uncontrolled dropping of the door leaf in the event that the drive system fails.

On each side of the door leaf, the weight-compensation device comprises a cable unit extending in the region of the respective guide rail, with a spring unit positioned in a horizontal section of the guide rail. Each cable unit comprises two parallel running cables which are guided onto the spring unit. The first exposed ends are attached to the door leaf while the second exposed ends are locally secured in place. Among other things, the cable ends are secured locally in place with components which form a cable-tension compensation device in the form of a counterpoise. The cable-tension compensation device functions to evenly distribute the tension in the cables.

Cable units of this type are in principle protected against breakage in that each cable unit is configured with two separate cables which consequently form a redundant system. That is to say, if one of the cables of the cable unit breaks, the still intact cable can maintain the function of the cable unit and thus can maintain the function of the weight-compensation device.

However, this system has the disadvantage that the separate cables used in the cable unit require an undesirably high structural expenditure. In particular, it is a disadvantage that separate fastening means must be provided at the exposed ends of each cable.

### SUMMARY OF THE INVENTION

It is an object of the present invention to provide a drive system for a door of the aforementioned type which ensures the highest possible operational safety with the lowest possible structural expenditure.

The above and other objects are accomplished, wherein there is provided according to one embodiment, a weight compensation system for a motor driven door having a door leaf that is driven by a mechanism inside guide rails on a side of the door leaf to move the door between an opened position and a closed position, the weight compensation system comprising: a weight-compensation device comprising a cable unit and a spring unit arranged at least on one side of the door leaf, wherein the cable unit comprises a single cable; and a cable-tension compensation device at which the single cable is deflected to create two cable strands that are secured against breakage within the cable-tension compensation device, wherein the cable-tension compensation device is positioned one of locally fixed or secured to the door leaf so that two cable strands move at a distance to each other, and wherein exposed ends of the cable are guided together and attached to one of the door leaf or are positioned locally fixed, respectively.

The weight-compensation device of the door according to the invention can be realized with little structural expenditure. At the same time, this device has a high operational safety since it remains operational even in case of a cable breakage in a cable unit for the weight-compensation device.

The structural expenditure for the weight-compensation device is kept low because each cable unit consists of only a single cable. As a result, the number of cable ends belonging to each cable unit that must be attached to the door leaf and/or must be attached to locally fixed holders is reduced considerably as compared to cable units comprising several cables.

A cable-tension compensation device may be provided for each cable unit which ensures a compensation of the cable tensions in the two cable strands of the respective cable unit. In the process, the cable-tension compensation device itself functions to protect against a cable breakage. With a cable unit consisting only of a single circulating cable, it is thus achieved that even if one cable strand breaks, the remaining cable strand still remains operational, thereby maintaining the function of the weight-compensation device.

According to one embodiment of the invention, a safety device is assigned for this to the cable-tension compensation device which functions to hold in place the other cable strand if one cable strand breaks.

According to an embodiment, the cable-tension compensation device comprises a rod-shaped segment on which the cable is deflected and by which the cable is secured in position, wherein the rod-shaped segment may be a screw.

The rod-shaped segment can be inserted into different recesses of a locally fixed holder and can be secured therein.

The cable-tension compensation device embodied in this way has a simple design and can furthermore be operated easily and quickly.

The safety device assigned to the cable-tension compensation device is a safety device consisting of a locally fixed panel provided with two bore holes, wherein a cable strand is respectively guided through each bore hole. As a further component of the safety device, a bulging or thickened area is provided on and is fixedly connected to each cable strand in the region between the rod-shaped segment and the panel, wherein this thickened area has a larger diameter than the diameter of the bore hole assigned to the cable strand.

If a breakage occurs in one of the cable strands, this cable strand can move only far enough for the thickened area to come to rest against the panel, wherein the dimensioning of this thickened area securely prevents it from moving through the bore hole in the panel. As a result, it is ensured that the cable strand which is still intact is held in place at the safety device of the cable-tension compensation device and the tension of the still intact cable strand is thus maintained.

The safety device embodied in this way has a simple design, thereby ensuring a high operational safety. The panel may be embodied integrally with the holder for the cable-tension compensation device, meaning the safety device forms a single unit together with the cable-tension compensation device.

The weight-compensation device according to the invention can also be used for doors having different designs. In particular, the door can be a sectional door, a lift gate, a sectional roll-up door, a roller shutter, a tilt door or an overhead door.

### BRIEF DESCRIPTION OF THE DRAWINGS

In the following, the invention is explained with the aid of drawings, which show in:

FIG. 1 An embodiment of a door provided with a weight-compensation device;

FIG. 2 A partial representation of the door, showing the components of the weight-compensation device;

FIG. 3 A view from above of a cable-tension compensation device with associated safety device, designed for the weight-compensation device according to FIGS. 1 and 2;

FIG. 4 A cross-sectional view of the cable-tension compensation device shown in FIG. 3.

### DETAILED DESCRIPTION OF THE DRAWINGS

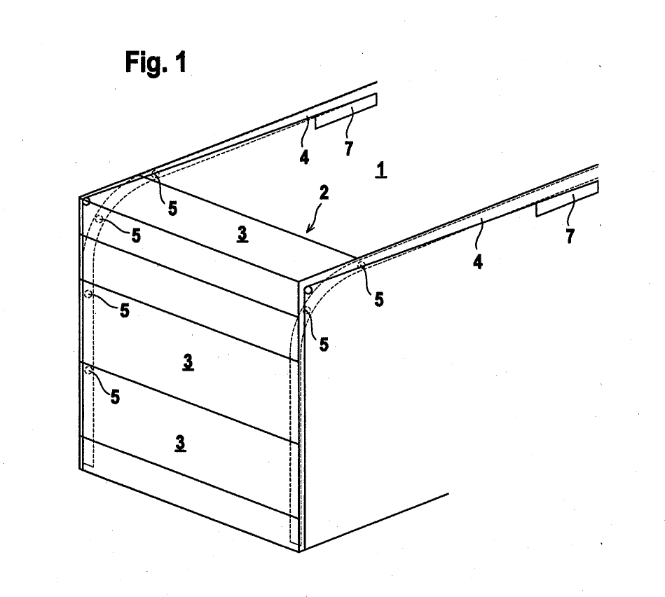

FIG. 1 shows an exemplary embodiment of a door 1, in particular a sectional roll-up door, comprising a door leaf 2 which consists of a multiple arrangement of hinged panels 3.

The door leaf 2 of the door 1 is guided inside guide rails, mounted on the side, which are installed in a building, a garage in the present case.

As shown in FIG. 1, the garage opening can be closed off with the door leaf 2 of the door 1. In the closed position of the door 1, the door leaf 2 is positioned in the region of the vertically extending segments of the guide rails 4. In the opened position of the door 1, the door leaf 2 is positioned below the garage ceiling in the segments of the guide rail 4 that extend in horizontal direction. Guide rolls 5 which move inside the guide rails 4 are provided on both side edges of the door leaf 2.

A drive system that is not shown herein is provided for the opening and closing of the door 1. In a manner known per se, the drive system comprises a motor-driven carriage which is guided to move in one of the guide rails 4 or in a separate rail. The carriage is hinged to the upper edge of the door leaf 2 via a push rod that is also not shown herein. The door can be opened and closed by moving the carriage back and forth in the region of the horizontal segment of the guide rail 4.

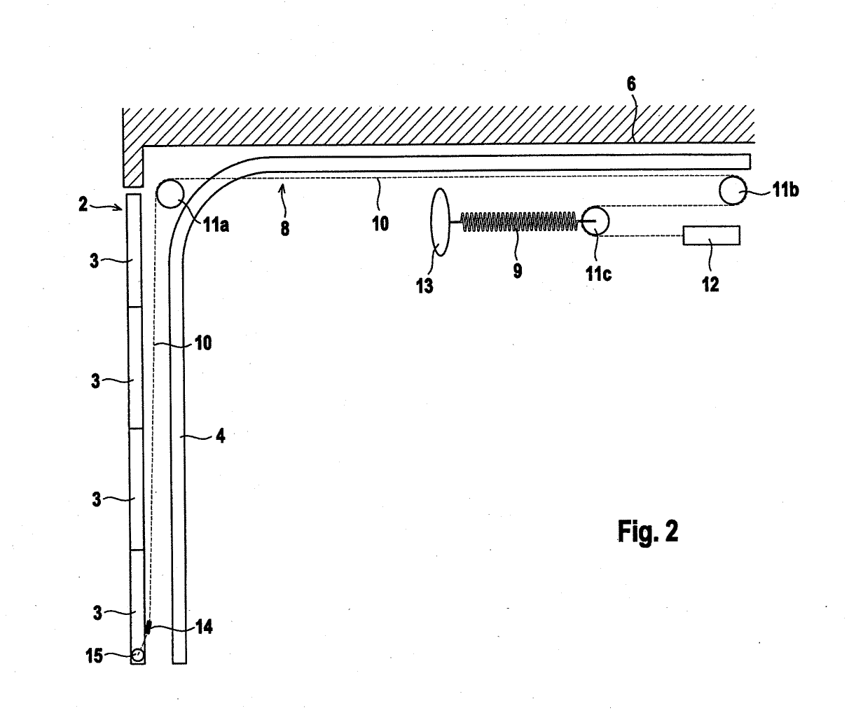

The components of a weight-compensation device for the door 1 are shown in further detail in FIG. 2, wherein the door leaf 2 is shown in the closed position therein. FIG. 2 provides a view from the side of a guide rail 4. FIG. 2 furthermore shows that the horizontal section of the guide rail 4 extends at a distance to the garage ceiling 6.

According to FIG. 1, housing profiles 7 in the form of square bars, with therein integrated components of the weight-compensation device, are attached to the undersides of the horizontal section of the guide rail 4. These components are shown in FIG. 2 without the housing profile 7.

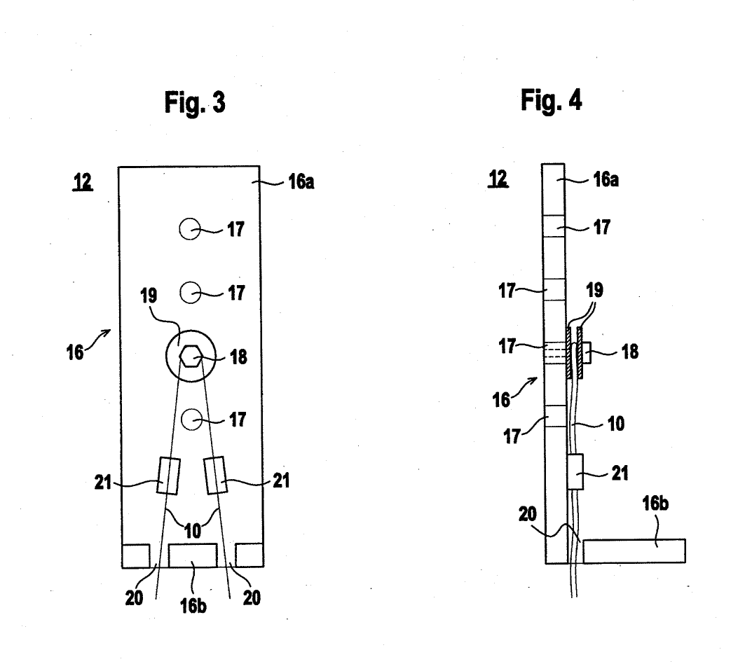

The weight-compensation device, which is provided with identically embodied components on the left and the right side of the door leaf, comprises a cable unit 8 and an associated spring unit 9 on each side of the door leaf 2. Each cable unit 8 comprises only a single cable 10 which is guided over deflection rollers 11a, 11b, 11c. Furthermore assigned to each cable unit 8 is a locally fixed cable-tension compensation device 12, shown only schematically in FIG. 2, along with its components which are shown in further detail in FIGS. 3 and 4.

The cable 10 of the cable unit 8 is deflected in the cable-tension compensation device 12, so that starting from this point two parallel cable strands are obtained which extend at a distance to each other and are guided over the deflection rollers 11a, 11b and 11c.

A first deflection roller 11a is located in the region of the garage ceiling 6. The deflection roller 11a is arranged in the curved section of the guide rail 4 which forms the transition region between the vertically extending and the horizontal segment of the guide rail 4.

The second deflection roller 11b is located at the end of the horizontal segment of the guide rail 4.

The spring unit 9 is attached with one longitudinal side end to the third deflection roller 11c. The other longitudinal side end of the spring unit 9 is positioned immovably on a holding element 13. The spring unit 9 is a tension spring arrangement. The individual tension springs can extend parallel to each other or can be positioned in a contiguous arrangement.

The exposed ends of the cable strands are securely connected to each other with the aid of a crimping 14. An eyelet 15 is provided at this location which can be formed either by the exposed ends of the cable strands or by a separate component. With this eyelet 15, the exposed ends of the cable strands are fixedly connected to the lower end of the door leaf 2.

The mode of operation of the weight-compensation device is such that the spring unit 9 exerts forces which counteract the force of the weight of the door leaf 2, thereby holding the door leaf 2 securely in place in each height position, meaning the door leaf is prevented from dropping.

The cable-tension compensation device 12 ensures that the tension in the cable is distributed evenly over the two cable strands.

As can be seen in FIGS. 3 and 4, the cable-tension compensation device 12 is provided with a locally fixed holder 16 which essentially consists of an L-shaped metal part. The holder 16 is provided with a bottom plate 16a, extending in a plane, which is used to attach the holder 16 to an immovable base. In longitudinal direction of the bottom plate 16a, several spaced-apart bore holes 17 are arranged along a straight line. A screw 18 that forms a pin-type segment can be inserted into these bore holes 17 and can be secured therein.

Two spacers 19 are fitted onto the screw 18 before the screw is inserted into one of the bore holes 17. The cable 10 of the cable unit 8 is guided between these spacers 19, so that it is deflected at the screw 18. The screw 18 is inserted with the spacers 19 and the cable 10 into one of the bore holes 17, depending on the desired cable tension, wherein the cable 10 is positioned between the spacers 19.

The cable 10 is deflected in the process on the screw 18, such that the tension is equalized in the two cable strands emanating from the deflection point. The screw 18 is subsequently tightened and the cable clamped in at this adjusted, desired position.

The cable-tension compensation device 12 embodied in this way can be operated reversibly since the screw 18 can be loosened at any time in order to readjust the tension in the two cable strands.

A safety device is assigned to the cable-tension compensation device 12 embodied in this way. A panel 16b is provided as a first component for the safety device, which panel is formed by the segment of the holder 16 that is oriented perpendicular to the bottom plate 16a. Two identical bore holes 20 with circular cross sections are provided at a distance to each other in this panel 16b.

A thickening in the form of a bulging or crimped area 21 is provided on each strand of the cable 10 as a further component of the safety device. Alternatively, the thickened area can also be embodied in the form of a metal casting or a clamping part. FIGS. 3 and 4 show that the crimped areas 21 are located in those cable strand segments which are located between the screw 18 and the panel 16b. The identically formed crimped areas 21 have a larger diameter than the bore holes 20 in the panel 16b. For this, the diameter of the bore holes 20 is dimensioned such that the cable 10 can be guided through with little play.

The safety device embodied in this way provides an efficient protection against a break in one of the cable strands.

If such a break occurs in one of the cable strands, the cable tension at that location will suddenly drop. However, the cable 10 cannot escape from the region of the cable-tension compensation device 12 because the crimped area 21 in the still intact cable strand comes to rest against the bore hole 20 and cannot slide through this hole. As a result of the now exposed end of the cable strand coming to rest against the bore hole 20 because of the crimped area 21, the cable strand is kept securely tensioned, so that the weight-compensation device is still functional.

In the present case, the panel 16b is formed as one piece with the bottom plate 16a.

The panel 16b and the bottom plate 16a of an alternative embodiment, however, can also be formed as two separate parts which can be connected to each other. In place of the bore holes 20, the panel 16b in that case can be provided with elongated holes into which the cable strands with the crimped areas 21 can be inserted easily. Once the panel 16b is attached to the bottom plate 16a, the elongated holes in the panel 16b are covered by the bottom plate 16a, such that the still exposed portions of the elongated holes form the bore holes 20 against which the crimped areas 21 are securely held in place.

1-14. (canceled)

15. A weight compensation system for a motor driven door having a door leaf that is driven by a mechanism inside guide rails on a side of the door leaf to move the door between an opened position and a closed position, the weight compensation system comprising:
a weight-compensation device comprising a cable unit and a spring unit arranged at least on one side of the door leaf, wherein the cable unit comprises a single cable; and
a cable-tension compensation device at which the single cable is deflected to create two cable strands that are secured against breakage within the cable-tension compensation device, wherein the cable-tension compensation device is positioned one of locally fixed or secured to the door leaf so that two cable strands move at a distance to each other, and wherein exposed ends of the cable are guided together and attached to one of the door leaf or are positioned locally fixed, respectively.

16. The system according to claim 15, wherein the cable-tension compensation device comprises a rod-shaped segment on which the cable is deflected and by which the cable is secured in position.

17. The system according to claim 16, wherein the rod-shaped segment comprises a screw.

18. The system according to claim 15, wherein the cable-tension compensation device comprises an immovably positioned holder having a plurality of recesses into which the rod-shaped segment is insertable and securable therein.

19. The system according to claim 15, wherein the cable-tension compensation device includes a safety device by which one strand of the cable is held in place in case of a breakage of the other cable strand.

20. The system according to claim 19, wherein the safety device comprises a locally fixed panel with two bore holes, wherein one cable strand is guided through a respective one of the bore hole, and wherein the safety device further includes thickened areas fixedly connected respectively to each cable strand in a region between the rod-shaped segment and the panel, wherein the thickened part has a diameter that exceeds a diameter of the bore hole assigned to the cable strand.

21. The system according to claim 20, wherein the bore holes in the panel are embodied identically, and wherein the diameter of the holes is adapted to the outside diameter of the cable strand such that the cable strands are guided with little play inside the bore holes.

22. The system according to claim 20, wherein the thickened areas of the cable strands comprise crimped areas.

23. The system according to claim 20, wherein the thickened areas comprise castings or clamping parts.

24. The system according to claim 20, wherein the panel is integral with the holder for the cable-tension compensation device.

25. The system according to claim 20, wherein the panel is a separate part that is attachable to the holder, wherein the panel includes elongated holes into which the cable strands with the thickened areas are insertable and that once the panel is attached to the holder, the elongated holes are in part covered, so that exposed sections of the elongated holes form the bore holes.

26. The system according to claim 15, wherein the spring unit comprises a tension spring arrangement.

27. The system according to claim 20, further including a deflection roller, wherein the spring unit has one end that is locally secured in place and another end that connected to the deflection roller across which the cable strands of the cable are guided.

28. A door forming a combination with the system according to claim 15, wherein the door is one of a sectional door, a lift gate, a sectional roll-up door, a roller shutter, a tilt door or an overhead door.
